(19) United States
(12) Patent Application Publication
(10) Pub. No.: US 2007/0268982 A1
(43) Pub. Date: Nov. 22, 2007

(54) FREQUENCY HOPPING OF PILOT TONES

(75) Inventor: Hakan Inanoglu, Acton, MA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 11/746,795

(22) Filed: May 10, 2007

Related U.S. Application Data
(60) Provisional application No. 60/800,677, filed on May 15, 2006.

(51) Int. Cl. H04L 1/02; H04B 7/02

(52) U.S. Cl. 375/267

(57) ABSTRACT

Presented are systems and methods for selecting a subband for a pilot tone in a communication system and transmitting and receiving data units that include pilot tones. In one embodiment, a method is presented comprising determining a channel parameter and selecting a subband for the pilot tone based upon the channel parameter and a subband previously assigned to the pilot tone. In another embodiment, the subband is incremented if the channel parameter meets a condition. In another embodiment, a method is present for transmitting multiple data units each having a pilot tone, wherein successively transmitted data units have pilot tones associated with incremented subbands. In another embodiment, the further incremented subband of each further subsequent data unit is the subband of the previously transmitted data unit incremented by a predetermined interval.

### CLAIM OF PRIORITY UNDER 35 U.S.C. §119

The present Application for Patent claims priority to Provisional Application No. 60/800,677 entitled “Frequency Hopping of Pilot Tones in a MIMO/OFDM System” filed May 15, 2006, assigned to the assignee hereof and hereby expressly incorporated by reference herein.

### BACKGROUND

I. Field

This disclosure relates to the field of multiplexed communications, and more particularly to systems and methods for improving the performance of multiple-input multiple-output (“MIMO”) systems by varying the frequency of MIMO pilot tones.

II. Background

The IEEE 802.11n standard for wireless communications, expected to be finalized in mid-2007, incorporates multiple-input multiple-output (MIMO) multiplexing into the orthogonal frequency-division multiplexing (OFDM) technology adopted by previous versions of the 802.11 standard. MIMO systems have the advantage of considerably enhanced throughput and/or increased reliability compared to non-multiplexed systems.

Rather than sending a single serialized data stream from a single transmitting antenna to a single receiving antenna, a MIMO system divides the data stream into multiple unique streams which are modulated and transmitted in parallel at the same time in the same frequency channel, each stream transmitted by its own spatially separated antenna chain. At the receiving end, one or more MIMO receiver antenna chains receives a linear combination of the multiple transmitted data streams, determined by the multiple paths that can be taken by each separate transmission. The data streams are then separated for processing, as described in more detail below.

In general, a MIMO system employs multiple transmit antennas and multiple receive antennas for data transmission. A MIMO channel formed by the N_{T} transmit and N_{R} receive antennas may be decomposed into N_{S} eigenmodes corresponding to independent virtual channels, where N_{S}≦min{N_{T}, N_{R}}.

In a wireless communication system, data to be transmitted is first modulated onto a radio frequency (RF) carrier signal to generate an RF modulated signal that is more suitable for transmission over a wireless channel. For a MIMO system, up to N_{T} RF modulated signals may be generated and transmitted simultaneously from the N_{T} transmit antennas. The transmitted RF modulated signals may reach the N_{R} receive antennas via a number of propagation paths in the wireless channel. The relationship of the received signals to the transmitted signals may be described as follows:
S_{R}=HS_{T}+n Eq. (1)
where S_{R} is a complex vector of N_{R} components corresponding to the signals received at each of the N_{R} receive antennas; S_{T} is a complex vector of N_{T} components corresponding to the signals transmitted at each of the N_{T} transmit antennas; H is a N_{R}×N_{T} matrix whose components represent the complex coefficients that describe the amplitude of the signal from each transmitting antenna received at each receiving antenna; and n is a vector representing the noise received at each receiving antenna.

The characteristics of the propagation paths typically vary over time due to a number of factors such as, for example, fading, multipath, and external interference. Consequently, the transmitted RF modulated signals may experience different channel conditions (e.g., different fading and multipath effects) and may be associated with different complex gains and signal-to-noise ratios (SNRs). In equation (1), these characteristics are encoded in matrix H.

To achieve high performance, it is often necessary to characterize the response of the wireless channel. The response of the channel may be described by parameters such as spectral noise, signal-to-noise ratio, bit rate, or other performance parameters. The transmitter may need to know the channel response, for example, in order to perform spatial processing for data transmission to the receiver as described below. Similarly, the receiver may need to know the channel response to perform spatial processing on the received signals to recover the transmitted data.

In many wireless communication systems, one or more reference signals, known as pilot tones, are transmitted by the transmitter to assist the receiver in performing a number of functions. The receiver may use the pilot tones for estimating channel response, as well as for other functions including timing and frequency acquisition, data demodulation, and others. In general, one or more pilot tones are transmitted with parameters that are known to the receiver. By comparing the amplitude and phase of the received pilot tone to the known transmission parameters of the pilot tone, the receiving processor can compute channel parameters, allowing it to compensate for noise and errors in the transmitted data stream. Use of pilot tones is discussed further in U.S. Pat. No. 6,928,062, titled “Uplink pilot and signaling transmission in wireless communication systems,” the contents of which are incorporated herein by reference.

### SUMMARY

In one embodiment, a method is provided for incrementing a subband of a pilot tone in a communication system, the method comprising receiving an indicator and incrementing the subband of the pilot tone in response to receipt of the indicator. In another embodiment, incrementing the subband of the pilot tone includes incrementing the subband by a predetermined interval. In still another embodiment, the communication system includes a transmitter and a receiver and the indicator is received by the transmitter from the receiver.

In a further embodiment, a method is provided for transmitting multiple data units wherein each of the multiple data units includes a pilot tone, the method comprising transmitting a first data unit, the pilot tone of which is associated with a first subband, and transmitting a subsequent data unit, wherein the pilot tone of the subsequent data unit is associated with an incremented subband. In still another embodiment, the incremented subband of the subsequent data unit is the subband of the first data unit, incremented by a predetermined interval. In still another embodiment, the method further comprises successively transmitting further subsequent data units, wherein the pilot tone of each further subsequent data unit is associated with a further incremented subband. In still another embodiment, the further incremented subband of each further subsequent data unit is the subband associated with a previously transmitted data unit, incremented by a predetermined interval. In still another embodiment, multiple data units are transmitted via a wireless MIMO/OFDM system.

In a further embodiment, a method is provided for transmitting multiple data units, each data unit including a pilot tone, the method comprising transmitting a first data unit, the pilot tone of which is assigned to a first subband, determining whether a pilot-hopping condition is met, and transmitting a subsequent data unit, wherein if the pilot-hopping condition is not met, the pilot tone of the subsequent data unit is associated with the first subband, and if the pilot-hopping condition is met, the pilot tone of the subsequent data unit is associated with an incremented subband. In still another embodiment, the incremented subband is the subband of the pilot tone of the previous data unit, incremented by a predetermined interval. In still another embodiment, determining whether the pilot-hopping condition is met further comprises determining a channel parameter. In still another embodiment, determining whether the pilot-hopping condition is met further comprises determining whether the channel parameter meets a threshold condition. In a further embodiment, each of the multiple data units further comprises a sequence identifier. In still another embodiment, determining whether the pilot-hopping condition is met further comprises receiving an indicator from a receiver.

In a further embodiment, an apparatus configured to transmit multiple data units is presented, the apparatus comprising an output adapted to be coupled to at least one antenna and a transmitter unit coupled to the output and operable to generate data units to be sequentially provided to the output, wherein each of the data units includes a pilot tone and wherein the transmitter unit is further operable to assign the pilot tone of the first data unit to a first subband and to assign the pilot tone of each subsequent data unit to an incremented subband. In still another embodiment, the incremented subband of each subsequent data unit is the subband of a previous data unit incremented by a fixed interval. In a further embodiment, each of the multiple data units further comprises a sequence identifier. In still another embodiment, each of the multiple data units is a data packet. In still another embodiment, each of the multiple data units is a burst. In still another embodiment, each of the multiple data units is a protocol data unit.

In a further embodiment, an apparatus configured to transmit multiple data units is presented, the apparatus comprising at least one output adapted to be coupled to at least one antenna and a transmitter unit coupled to the output and operable to generate data units to be sequentially provided to the output, each of the data units including a pilot tone, wherein the transmitter unit is further operable to assign the pilot tone of the first data unit to a first subband, determine whether a pilot-hopping condition is met, and, if the pilot-hopping condition is met, assign the pilot tone of each subsequent data to an incremented subband. In still another embodiment, the incremented subband of each subsequent data unit is the subband of a previous data unit, incremented by a predetermined interval. In still another embodiment, the transmitter unit is operable to assign the pilot tone of each subsequent data unit to the first subband if the pilot-hopping condition is not met. In still another embodiment, the transmitter unit is further operable to determine a channel parameter. In still another embodiment, the transmitter unit is further operable to determine whether the channel parameter meets a threshold condition.

In a further embodiment, an apparatus configured to process a received data unit is presented, wherein the received data unit comprising a sequence identifier and a pilot tone assigned to a subband, the apparatus comprising at least one input adapted to be coupled to at least one antenna and a receiver unit coupled to the input, the receiver unit configured to receive the data unit from the input, determine the sequence identifier of the data unit, and determine the subband assigned to the pilot tone of the received data unit based upon the sequence identifier of the data unit. In still another embodiment, the receiver unit is further configured to determine the subband assigned to the pilot tone of the received unit by incrementing the subband assigned to a previously received data unit. In still another embodiment, the subband assigned to the previously received data unit is incremented by an interval that is based upon the sequence identifier of the data unit.

In a further embodiment, an apparatus configured to select a subband to be assigned to a pilot tone is presented, the apparatus comprising means for determining a channel parameter and means for selecting the subband to be assigned to a pilot tone based upon the channel parameter and a subband previously assigned to the pilot tone. In still another embodiment, the apparatus further comprises means for determining whether the channel parameter satisfies a threshold condition, and means for incrementing the subband previously assigned to the pilot tone by a predetermined interval and selecting the incremented subband as the subband to be assigned to the pilot tone, if the channel parameter fails the threshold condition. In still another embodiment, the channel parameter is a signal-to-noise ratio. In still another embodiment, the channel parameter is a bit-error-rate.

In a further embodiment, a machine-readable medium carrying instructions for carrying out a method by one or more processors is described, the instructions comprising instructions for determining a channel parameter and instructions for selecting the subband to be assigned to the pilot tone based upon the channel parameter and a subband previously assigned to the pilot tone.

In a further embodiment, an apparatus configured to transmit multiple data units is presented, wherein each of the multiple data units includes a pilot tone, the apparatus comprising means for transmitting a first data unit, the pilot tone of the first data unit being assigned to a first subband, means for determining whether a pilot-hopping condition is met, and means for transmitting a subsequent data unit, wherein if the pilot-hopping condition is not met, the pilot tone of the subsequent data unit is associated with the first subband, and, if the pilot-hopping condition is met, the pilot tone of the subsequent unit is associated with an incremented subband. In still another embodiment, the incremented subband is the subband of the previous data unit, incremented by a predetermined interval. In still another embodiment, the means for determining whether a pilot-hopping condition is met further comprises means for determining a channel parameter. In still another embodiment, the means for determining whether a pilot-hopping condition is met further comprises means for determining whether the channel parameter meets a threshold condition. In still another embodiment, the means for determining whether a pilot-hopping condition is met further comprises means for receiving an indicator from a receiver.

In a further embodiment, a machine-readable medium carrying instructions for carrying out a method by one or more processors is presented, the instructions comprising instructions for transmitting a first data unit including a pilot tone assigned to a first subband, instructions for determining whether a pilot-hopping condition is met, and instructions for transmitting a subsequent data unit including a second pilot tone, wherein if the pilot-hopping condition is not met, the second pilot tone is associated with the first subband, and, if the pilot-hopping condition is met, the second pilot tone is associated with an incremented subband.

In a further embodiment, an apparatus configured to process a received data unit is presented, the received data unit comprising a sequence identifier and a pilot tone associated with a subband, the apparatus comprising means for determining the sequence identifier of the data unit and means for determining the subband associated with the pilot tone of the received data unit based upon the sequence identifier of the data unit. In still another embodiment, the means for determining the subband assigned to the pilot tone of the received data unit further comprises means for incrementing by an interval the subband associated with a previously received data unit, wherein the interval is based upon the sequence identifier of the data unit. In still another embodiment, a machine-readable medium carrying instructions for carrying out a method is presented, the instructions comprising instructions for determining the sequence identifier of the data unit, and instructions for determining the subband associated with the pilot tone of the received data unit based upon the sequence identifier of the data unit.

### BRIEF DESCRIPTION OF THE DRAWINGS

Exemplary embodiments of systems and methods according to the present disclosure will be understood with reference to the accompanying drawings, which are not intended to be drawn to scale. In the drawings, each identical or nearly identical component that is illustrated in various figures is represented by a like designator. For purposes of clarity, not every component may be labeled in every drawing. In the drawings:

The features and nature of the present disclosure will become more apparent from the detailed description set forth below when taken in conjunction with the drawings in which like reference characters identify correspondingly throughout.

FIG. 1 is a schematic diagram of a wireless network.

FIG. 2 is a block diagram of a transmitting station and a receiving station.

FIG. 3 is a schematic representation of pilot tone hopping over subbands.

FIG. 4 is a schematic representation of an embodiment of an apparatus for selecting a subband for a pilot tone.

FIG. 5 is a schematic representation of an embodiment of an apparatus for transmitting data units that include pilot tones.

FIG. 6A is a schematic representation of an embodiment of an apparatus for evaluating whether a pilot-hopping condition exists.

FIG. 6B is a schematic representation of another embodiment of an apparatus for evaluating whether a pilot-hopping condition exists.

FIG. 7 is a schematic representation of an embodiment of an apparatus for determining the subband assigned to a pilot tone of a received data unit.

### DETAILED DESCRIPTION

The word “exemplary” is used herein to mean “serving as an example, instance, or illustration.” Any embodiment or design described herein as “exemplary” is not necessarily to be construed as preferred or advantageous over other embodiments or designs.

The effectiveness of pilot tones is limited by noise and interference. These can degrade the reference function of the pilot tones by introducing spurious components into the amplitude and phase of the received pilot tones. To preserve the integrity of the pilot tones against noise and interference, a technique for incremental frequency hopping of pilot tones is described. Using the method of the disclosure in an OFDM/MIMO system, pilot tones can be hopped over the frequency band if noise or interference from other systems starts to degrade the system performance.

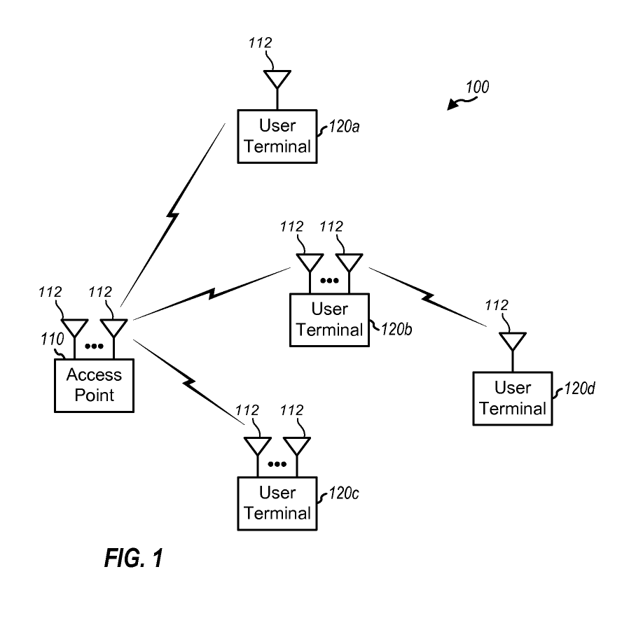

FIG. 1 shows an exemplary wireless network 100 with an access point 110 and one or more user terminals 120. Access point 110 is generally a fixed station that communicates with the user terminals, such as a base station or a base transceiver subsystem (BTS). The user terminals 120 may be fixed or mobile stations (STA), wireless devices, or any other user equipment (UE). The user terminals 120 may communicate with the access point 110. Alternatively, a user terminal 120 may also communicate peer-to-peer with another user terminal 120. In an exemplary embodiment, access point 110 is a wireless network hub and the user terminals 120 are one or more computers equipped with wireless network adapters. In an alternative exemplary embodiment, access point 110 is a cellular communication station and user terminals 120 are one or more cellular telephones, pagers, or other communication devices. Persons skilled in the art will recognize other systems that can be represented generally as illustrated in FIG. 1.

The access point 110 may be equipped with a single antenna 112 or multiple antennas 112 for data transmission and reception. Similarly, each user terminal 120 may also be equipped with a single antenna 112 or multiple antennas 112 for data transmission and reception. In the exemplary embodiment illustrated in FIG. 1, access point 110 is equipped with multiple (e.g., two or four) antennas 112, user terminals 120a and 120d are each equipped with a single antenna 112, and user terminals 120b and 120c are each equipped with multiple antennas 112. In general any number of antennas 112 may be used; it is not necessary that the user terminals 120 have the same number of antennas 112 as one another or that they have the same number of antennas 112 as the access point 110.

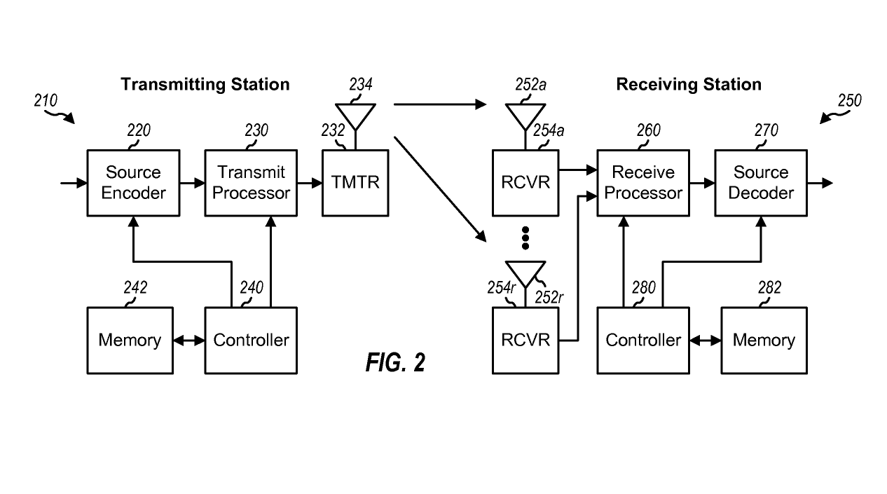

Each of the user terminals 120 and access point 110 in wireless network 100 includes either a transmitting station, a receiving station, or both. FIG. 2 illustrates a block diagram of An exemplary transmitting station 210 and an exemplary receiving station 250. In the embodiment illustrated in FIG. 2, transmitting station 210 is equipped with a single antenna 234, and receiving station 250 is equipped with multiple (e.g., N_{R}=2) antennas 252a-r. In general, both transmitting station 210 and receiving station 250 may have multiple antennas; in MIMO systems the transmitting station 210 and receiving station 250 typically both have multiple antennas.

Referring again to FIG. 2, at transmitting station 210, a source encoder 220 encodes raw data such as voice data, video data, or any other data that may be transmitted over a wireless network. The encoding is typically based on any of a wide variety of source encoding schemes known in the art, such as Enhanced Variable Rate Codec (EVRC) encoder for voice, an H.324 encoder for video, and many other known encoding schemes. The choice of source encoding scheme is dependent on the end application of the wireless network.

The source encoder 220 may also generate traffic data. A transmit processor 230 receives the traffic data from source encoder 220, processes the traffic data in accordance with a data rate selected for transmission, and provides output chips. A transmitter unit (TMTR) 232 processes the output chips to generate a modulated signal. Processing by the transmitter unit 232 may include digital-to-analog conversion, amplification, filtering, and frequency upconverting. The modulated signal generated by the transmitter unit is then transmitted via antenna 234. In the case of a multiple-antenna transmitter unit 232, the processing by the transmitter unit may also include multiplexing the output signal for transmission via multiple antennas.

At receiving station 250, N_{R} antennas 252a through 252r receive the transmitted signal (or, if the transmitter unit 232 included multiple transmit antennas and transmitted a multiplexed signal, antennas 252a through 252r each receive a linear combination of the signals transmitted by each of the transmit antennas). Each antenna 252 provides a received signal to a respective receiver unit (RCVR) 254. Each receiver unit 254 processes its received signal. In an exemplary embodiment, receiver units 254 each process the signal via digital sampling, providing a stream of input samples to a receive processor 260. Receive processor 260 processes the input samples from all R receiver units 254a through 254r in a manner complementary to the processing performed by transmit processor 230, and provides output data, which is the statistical estimate of the content of the traffic data sent by transmitting station 210. A source decoder 270 processes the output data in a manner complementary to the processing performed by source encoder 220, and provides decoded data as output for further use or processing by other components.

In an exemplary embodiment, controllers 240 and 280 direct the operation of the processing units at transmitting station 210 and receiving station 250, respectively. The transmitting station 210 and receiving station 250 may also include memory units 242 and 282 that store data and/or program codes used by controllers 240 and 280, respectively.

Signal Processing in Orthogonal Frequency-Division Multiplexing (OFDM) Systems.

Using an OFDM scheme effectively partitions the overall system bandwidth into a number (N_{F}) of orthogonal subbands. These orthogonal subbands are sometimes referred to as tones, frequency bins, or frequency subchannels. With OFDM, each subband is associated with a respective subcarrier upon which data may be modulated. For a MIMO-OFDM system, each subband may be associated with a number of eigenmodes, and each eigenmode of each subband may be viewed as an independent transmission channel.

As noted previously, MIMO-OFDM systems employ pilot tones for estimating channel response, timing and frequency acquisition, data demodulation, or other functions. In an exemplary MIMO-OFDM system, these pilot tones are structured as follows.

The MIMO-OFDM system bandwidth is partitioned into N_{F} orthogonal subbands. In general the number of orthogonal subbands depends upon the number of antennas at the transmit and receive ends of the MIMO system. In an exemplary embodiment, N_{F}=64, but in some embodiments, the described techniques can be readily applied generally to MIMO systems operating with any number of orthogonal subbands as well as other OFDM subband structures.

The pilot tones are transmitted on a predetermined number of subbands. The number and spacing of the OFDM subbands may be selected to optimize the balance of improved channel estimation and increased overhead, or loss of effective bandwidth, that arises from reserving certain subbands for pilot tones. In an exemplary embodiment where N_{F}=64, for example, four pilot tones may be employed, providing enough data for estimation of channel performance without sacrificing too much data bandwidth.

A number of factors may contribute to phase rotation on an OFDM symbol, such as the sampling time of the symbol or phase noise of local oscillators. Such phase rotations can contribute to error in the received signal. When using pilot tones, the processing algorithms or circuits at the receiver can estimate these phase rotations from the pilot tones, which are transmitted with known parameters, and correct the data tones accordingly. Therefore, accurate and precise measurement of phase information in the pilot tones is very important to the overall system performance. Any interference to the pilot tones (particularly interference that introduces phase shifts that are not also present in the data tones) may degrade the system performance significantly as phase tracking on the data tones may be lost. When spurious phase shifts are present in the pilot tones, receiver processing may overcorrect the data tones or correct for phase shifts that are not present in the data tones.

To address narrowband interference problems that can introduce phase errors into the pilot tones, the embodiments of the present disclosure provide techniques for frequency-hopping pilot tones incrementally. In an OFDM-MIMO system employing the techniques disclosed herein, pilot tones may be hopped to different positions in the frequency band when interference or any other source of degraded channel response is observed to be degrading the system's performance.

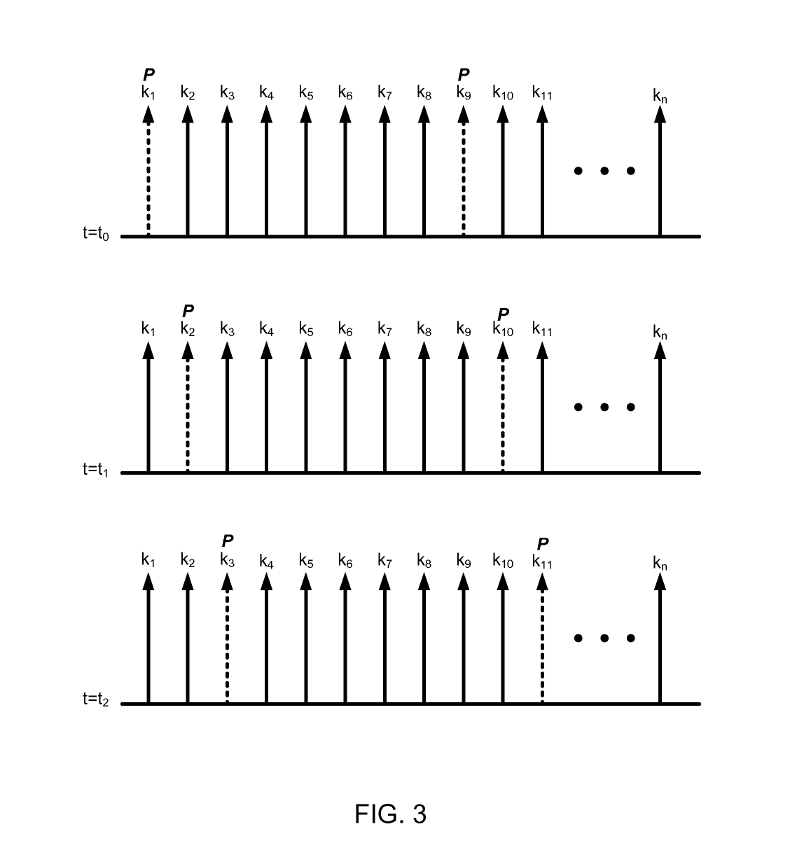

FIG. 3 schematically illustrates pilot-tone hopping in an exemplary OFDM-MIMO system having N_{F} subbands. A subcarrier corresponding to each subband is represented in FIG. 3 by a vertical line in the schematically represented frequency spectrum of the channel. The subcarriers may be referred to by an index k, running from 1 to N_{F}. At any given time, some of the subbands are reserved for use as pilot tones, while the subcarriers in the other subbands may be modulated to carry transmitted data or other system information. At some time t=t₀, in the exemplary embodiment illustrated in FIG. 3, subband k=1 and every eighth subband thereafter are designated as pilot tones, indicated by a dotted line and by the letter P above those subbands. Again it will be understood that this is merely exemplary, and the techniques described herein may be applied to any number of pilot tones, placed anywhere within the channel, with whatever spacing is desired.

When interference and/or phase noise in the pilot tones interferes with system performance, the system can “hop” the pilot tones, reassigning the role of pilot tone to different subbands from those initially assigned. (Trigger conditions that might cause the system to hop the pilot tones are discussed below.) In FIG. 3, for example, at time t=t₁, the system has advanced the pilot tones by one subband. Thus in the embodiment illustrated in FIG. 3, at t=t₁ the pilot tones are assigned to subbands k=2, 10, etc. Similarly, should the system advance the pilot tones again, at some later time t=t₂ the pilot tones may be assigned to subbands k=3, 11, etc., as illustrated in FIG. 3. In an exemplary embodiment, if the highest frequency subband k=N_{F} is designated a pilot tone, then when the system hops or advances the pilot tones, the assignment will “wrap” to the lowest portion of the channel; i.e., the subband k=1 will be designated as a pilot tone.

In one embodiment, the pilot tone hopping is triggered when channel conditions fall below a threshold. For example, the threshold condition may be bitrate falling below a certain threshold level, phase noise increasing above a threshold level, the signal-to-noise ratio falling below a threshold level, bit-error-rate increasing above a threshold level, or a threshold degradation in any other channel parameter that is monitored by the system. Other channel parameters that may be monitored by an exemplary system include correlation, channel coherence time, frequency and rms delay spread. The threshold condition may be evaluated by processing that occurs at the transmitting end or by processing that occurs at the receiver. In one embodiment spectral noise, signal-to-noise ratio, and/or bit rate are monitored at the receiver end; other parameters may be monitored at the transmitter end. In embodiments in which the threshold condition is evaluated at the receiver end, upon detection of the threshold condition the receiver will send to the transmitter a flag, signal, or other indicator. In such embodiments, the transmitter is programmed to interpret the indicator as a request to begin hopping the pilot tones, and begins incrementing the pilot tones in response to receiving the indicator.

Upon detection of a positive threshold condition, the transmitter then increments the pilot tones by some fixed number N_{I} of subbands. In the embodiment illustrated in FIG. 3, N_{I}=1, but other values of N_{I} may be employed. In one embodiment, the pilot tones may be incremented once (by an interval of N_{I} subbands) upon detection of the threshold condition. In another embodiment, the system may repeatedly increment the pilot tones by N_{I} subbands, checking the threshold condition with each increment, and cease incrementing the pilot tones when the threshold condition is no longer satisfied, i.e., when one or more monitored channel parameters have returned to their desired ranges. In still another embodiment, once the threshold condition is detected, the pilot tones may be repeatedly incremented with each consecutive packet or burst transmitted by the transmitter, wrapping the pilot tones back to k=1 when they increment past the high frequency end of the channel. Finally, in another embodiment, the system may be programmed to always vary the pilot tones independent of any threshold condition. For example, such a system may be programmed to initiate transmission with subband k=1 assigned as a pilot tone, and then increment the pilot tones by one subband with each transmitted packet or burst, wrapping back to k=1 when the pilot tones increment past the high frequency end of the channel. The hopping of tones may continue for a predetermined time or a predetermined number of frames, or it may be ceased when the threshold condition is no longer detected at the transmitter or at the receiver. Alternatively hopping may be ceased upon the detection of a different threshold condition at either the transmitter or receiver.

In an exemplary embodiment, when it is determined that the pilot tones should be hopped in frequency, all of the tones in the OFDM symbol are shifted by N_{I} subbands. Thus, for example (referring again for FIG. 3), at t=t₀, subband k=1 is designated for a pilot tone while subbands k=2-8 carry data (and similarly for subbands k=9 to k=N_{F}). After a pilot tone hop (with N_{I}=1), at t=t₁, subband k=2 is designated for a pilot tone, and the data corresponding to the data previously in subbands k=2-8 is carried in subbands k=3-9; and similarly for subbands k=9 to k=N_{F}; the data corresponding to the data previously in subband k=N_{F} is carried in subbands k=1. In other words, when the tones are hopped, each tone is pushed forward by N_{I} subbands and tones that would be hopped out of the channel by that increment “wrap” around to occupy the first tones' subbands. Alternatively the tones could be hopped in the reverse direction, decrementing each tone by N_{I} and wrapping lower tones to the higher end of the spectrum.

To correctly process received signals, in some embodiments the receiver can determine for every received packet, burst, or protocol data unit (PDU) which subbands are pilot tones and which are data tones. Therefore, in one embodiment, each packet, burst, or PDU is marked by the transmitter with a sequence identifier, such as a sequence number or other unique identifier that locates the position of the packet in a sequence of transmitted packets. The receiver can use this identifier to determine which subbands are assigned to pilot tones for that packet, burst, or PDU. For example, if the receiver knows that pilot tone hopping began with the transmission of the packet bearing sequence number N_{H}, and also knows that in each subsequent packet the pilot tones were advanced by N_{I} subbands, when the receiver receives a data packet bearing sequence number N_{H}+p, the receiver can compute the indices of the subbands corresponding to the pilot tones for that packet by adding (p N_{I}) mod (N_{F}) to each of the indices of the original subbands. This computation advances the pilot tones by the correct number of steps and wraps the pilot tones back to subband k=1 when they advance past the last subband k=N_{F}.

To correctly determine the pilot tones from the sequence number of a data packet, burst, or PDU, in some embodiments the receiver knows the sequence number at which pilot hopping began. In embodiments in which the receiver sends instruction to the transmitter to begin pilot hopping, the receiver may store the packet number at which it sent that instruction. In embodiments in which the transmitter determines when pilot hopping begins, the transmitter may send a signal to the receiver indicating the sequence number at which pilot hopping begins.

In an alternative embodiment, the packets, bursts, or PDUs themselves may include information encoding the indices or the frequencies of the subbands directly, so that the receiver may simply read them from the transmission.

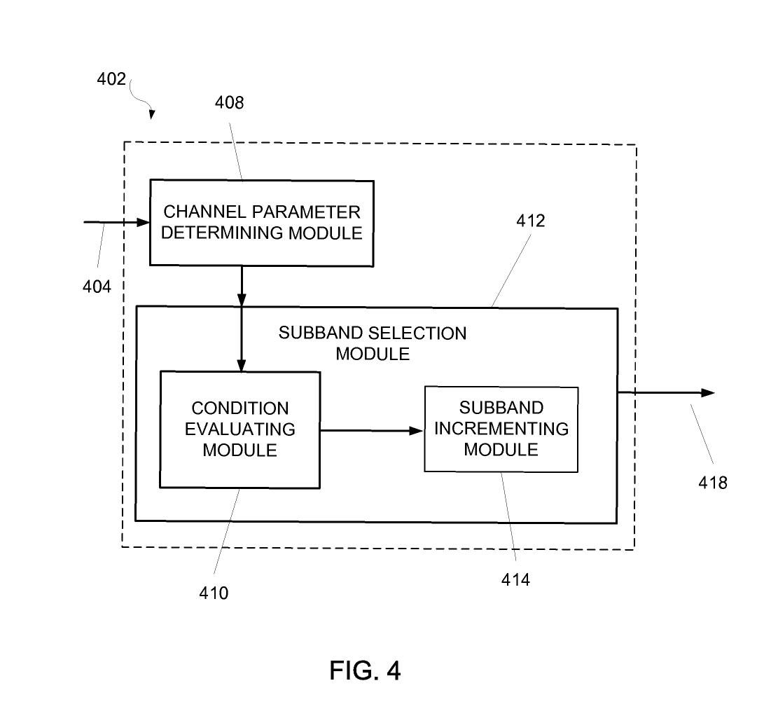

Exemplary embodiments of apparatus configured to carry out some of the methods disclosed herein are illustrated in FIGS. 4-6. As discussed further below, each of these devices and/or their components may be implemented in hardware, software, or a combination thereof.

An exemplary embodiment of an apparatus configured to select a subband to be assigned to a pilot tone is illustrated in FIG. 4. The apparatus 402 includes a module 408 for determining a channel parameter such as bitrate, phase noise, signal-to-noise ratio, or any other channel parameter. The channel parameter determining module 408 may receive an input 404, such as a signal from a receiver, that may be processed to determine the values of one or more channel parameters. In an exemplary embodiment, the apparatus also includes a subband selection module 412 that uses the channel parameter to assign a subband to the pilot tone, e.g., to determine whether the subband previously assigned to the pilot tone should be incremented. The subband selection module 412 may include a condition evaluating module 410 that determines whether the channel parameter (determined by module 408) meets a pilot-hopping condition as described above. A subband incrementing module 414 then increments the subband if necessary based upon the output of the condition evaluating module 410. The output 418 of the apparatus 402 is, in an exemplary embodiment, a signal indicating the subband to be assigned to the pilot tone. This signal 418 may then be passed, for example, to a processor that generates data units for transmission.

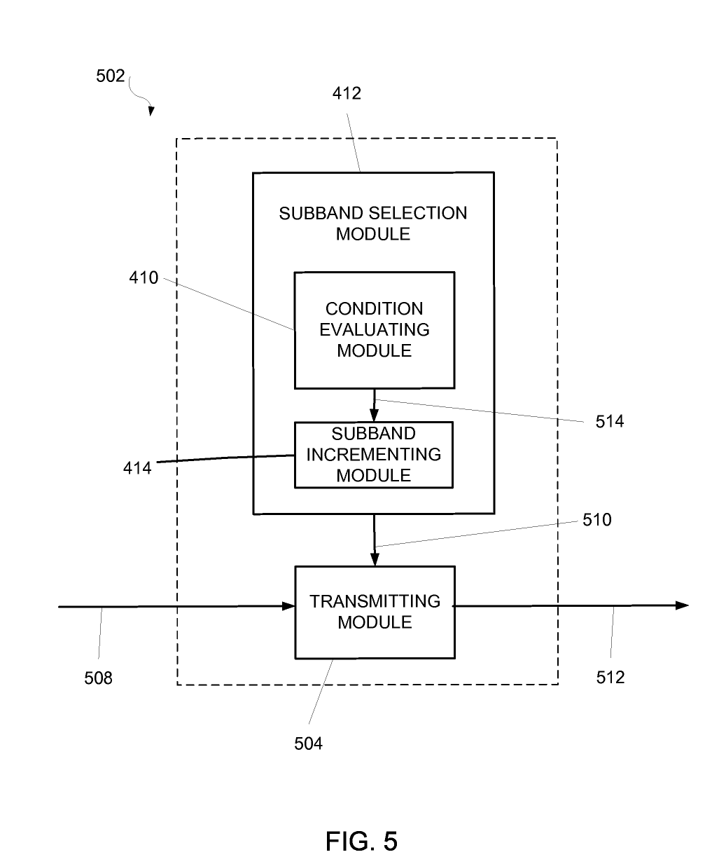

FIG. 5 illustrates an exemplary embodiment of an apparatus for transmitting multiple data units, each data unit including a pilot tone. The apparatus 502 includes a transmitting module 504. The transmitting module 504 may receive input 508 that includes information to be encoded in a data unit for transmission. The transmitting module 504 also receives input 510 from a subband selection module 412 as described above in connection with FIG. 4. Input 510 tells the transmitting module what subband to use as a pilot tone in the data unit to be transmitted. Thus the output 512 of the transmitting module 504 includes a data unit carrying encoded information from input 508 and a pilot tone in a subband determined by the subband selection module 412.

In an exemplary embodiment of the apparatus 502 for transmitting data units, the subband selection module 412 includes a condition evaluating module 410 and a subband incrementing module 414 as described above in connection with FIG. 4. The subband incrementing module 414 increments the subband if necessary according to the output 514 of the condition evaluating module 410. For example, if the output 514 of the condition evaluating module 410 indicates that the pilot-hopping condition is met, then the subband incrementing module 414 increments the subband; on the other hand, if the output 514 of the condition evaluating module 410 indicates that the pilot-hopping condition is not met, then the subband selection module 412 assigns the same subband as was assigned for the pilot tone of a previously transmitted data unit.

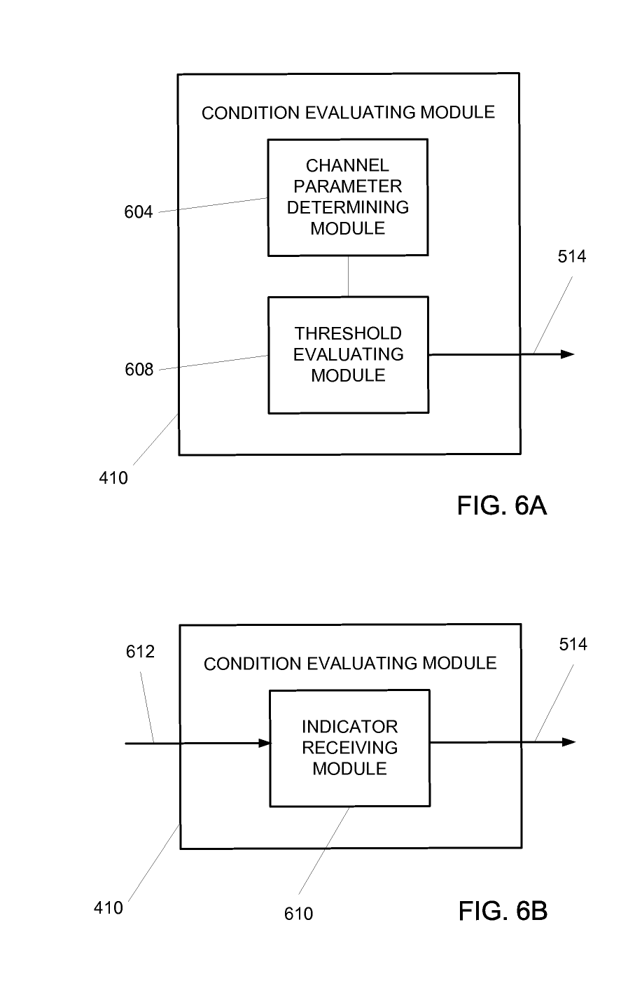

Exemplary embodiments of condition evaluating module 410 are illustrated in FIG. 6A and FIG. 6B. In the embodiment illustrated in FIG. 6A, the condition evaluating module 410 determines a channel parameter (via channel parameter determining module 604) and then determines whether the channel parameter meets a threshold condition (via the threshold evaluating module 608). The output 514 of the condition evaluating module is passed to the subband incrementing module 414 as illustrated in FIG. 5. In an alternative embodiment, the channel parameter determining module 604 is a separate module rather than a component of the condition evaluating module 410. In such an embodiment the channel parameter determining module 604 passes the channel parameter to the condition evaluating module 410 for processing.

Finally, in the embodiment illustrated in FIG. 6B, the condition evaluating module 410 includes an indicator receiving module that receives an indicator 612, the indicator 612 indicating whether or not the subband should be incremented.

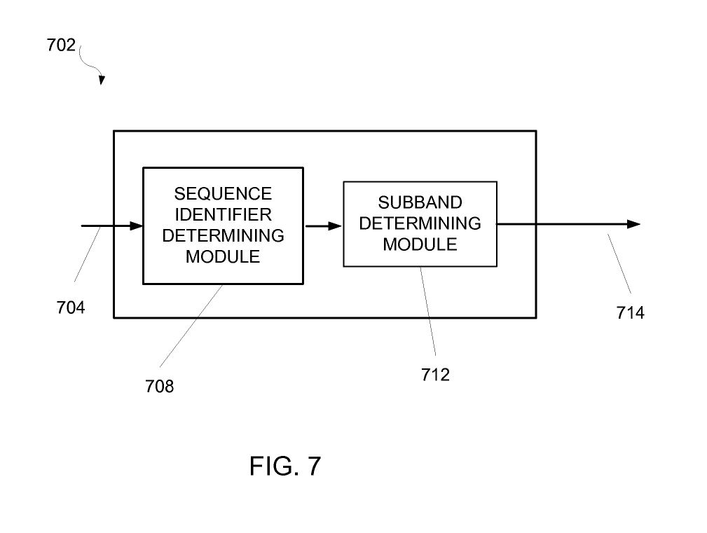

FIG. 7 illustrates an embodiment of an apparatus 702 for processing a received data unit having a sequence identifier and a pilot tone associated with a subband. The apparatus 702 receives input 704 that includes the data unit. A sequence identifier determining module 708 processes the input 704 to determine the sequence identifier. A subband determining module takes the sequence identifier from the sequence identifier determining module 708 and uses it to determine the received data unit's pilot tone, as discussed previously. For example, in an exemplary embodiment, the subband determining module 712 determines the subband by incrementing the subband associated with a previously received data unit by an interval that is based upon the sequence identifier of the received data unit. The output 714 of the apparatus 702 may be a signal indicating the subband of the pilot tone in the data unit being processed.

The techniques described herein may be implemented in MIMO wireless communications systems, as well as in any communication system, wireless or otherwise, in which one or more pilot tones are employed. The techniques described herein may be implemented in a variety of ways, including hardware implementation, software implementation, or a combination thereof. For a hardware implementation, the processing units used to process data for transmission at a transmitting station and/or for receipt at a receiving station may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof. In embodiments in which the transmit and receive stations include multiple processors, the processors at each station may share hardware units.

For a software implementation, the data transmission and reception techniques may be implemented with software modules (e.g., procedures, functions, and so on) that perform the functions described herein. The software codes may be stored in a memory unit (e.g., memory unit 242 or 282 in FIG. 2) and executed by a processor (e.g., controller 240 or 280). The memory unit may be implemented within the processor or external to the processor.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A method for incrementing a subband of a pilot tone in a communication system, the method comprising:
receiving an indicator; and
incrementing the subband of the pilot tone in response to receipt of the indicator.

2. The method of claim 1, wherein incrementing the subband of the pilot tone includes incrementing the subband by a predetermined interval.

3. The method of claim 1, wherein the communication system includes a transmitter and a receiver, and wherein the indicator is received by the transmitter from the receiver.

4. A method for transmitting multiple data units wherein each of the multiple data units includes a pilot tone, the method comprising:
transmitting a first data unit, wherein the pilot tone of the first data unit is associated with a first subband; and
transmitting a subsequent data unit, wherein the pilot tone of the subsequent data unit is associated with an incremented subband.

5. The method of claim 4, wherein the incremented subband of the subsequent data unit is the subband of the first data unit, incremented by a predetermined interval.

6. The method of claim 4, further comprising:
successively transmitting further subsequent data units, wherein the pilot tone of each further subsequent data unit is associated with a further incremented subband.

7. The method of claim 6, wherein the further incremented subband of each further subsequent data unit is the subband associated with a previously transmitted data unit, incremented by a predetermined interval.

8. The method of claim 4, wherein multiple data units are transmitted via a wireless MIMO/OFDM system.

9. A method for transmitting multiple data units wherein each of the multiple data units includes a pilot tone, the method comprising:
transmitting a first data unit, wherein the pilot tone of the first data unit is assigned to a first subband;
determining whether a pilot-hopping condition is met; and
transmitting a subsequent data unit, wherein
if the pilot-hopping condition is not met, the pilot tone of the subsequent data unit is associated with the first subband; and
if the pilot-hopping condition is met, the pilot tone of the subsequent data unit is associated with an incremented subband.

10. The method of claim 9, wherein the incremented subband is the subband of the pilot tone of the previous data unit, incremented by a predetermined interval.

11. The method of claim 9, wherein determining whether the pilot-hopping condition is met further comprises determining a channel parameter.

12. The method of claim 11, wherein determining whether the pilot-hopping condition is met further comprises determining whether the channel parameter meets a threshold condition.

13. The method of claim 12, wherein each of the multiple data units further comprises a sequence identifier.

14. The method of claim 12, wherein determining whether the pilot-hopping condition is met further comprises receiving an indicator from a receiver.

15. An apparatus configured to transmit multiple data units comprising:
an output adapted to be coupled to at least one antenna; and
a transmitter unit coupled to the output, and operable to generate data units to be sequentially provided to the output, wherein each of the data units includes a pilot tone; and
wherein the transmitter unit is further operable to assign the pilot tone of the first data unit to a first subband, and to assign the pilot tone of each subsequent data unit to an incremented subband.

16. The apparatus of claim 15, wherein the incremented subband of each subsequent data unit is the subband of a previous data unit incremented by a fixed interval.

17. The apparatus of claim 15, wherein each of the multiple data units further comprises a sequence identifier.

18. The apparatus of claim 15, wherein each of the multiple data units is a data packet.

19. The apparatus of claim 15, wherein each of the multiple data units is a burst.

20. The apparatus of claim 15, wherein each of the multiple data units is a protocol data unit.

21. An apparatus configured to transmit multiple data units comprising:
at least one output adapted to be coupled to at least one antenna; and
a transmitter unit coupled to the output, and operable to generate data units to be sequentially provided to the output, wherein each of the data units includes a pilot tone;
wherein the transmitter unit is further operable to:
assign the pilot tone of the first data unit to a first subband;
determine whether a pilot-hopping condition is met; and
if the pilot-hopping condition is met, assign the pilot tone of each subsequent data to an incremented subband.

22. The apparatus of claim 21, wherein the incremented subband of each subsequent data unit is the subband of a previous data unit, incremented by a predetermined interval.

23. The apparatus of claim 21, wherein the transmitter unit is operable to assign the pilot tone of each subsequent data unit to the first subband if the pilot-hopping condition is not met.

24. The apparatus of claim 21, wherein the transmitter unit is further operable to determine a channel parameter.

25. The apparatus of claim 24, wherein the transmitter unit is further operable to determine whether the channel parameter meets a threshold condition.

26. An apparatus configured to process a received data unit, the received data unit comprising a sequence identifier and a pilot tone assigned to a subband comprising:
at least one input adapted to be coupled to at least one antenna; and
a receiver unit coupled to the input, the receiver unit configured to receive the data unit from the input;
determine the sequence identifier of the data unit; and
determine the subband assigned to the pilot tone of the received data unit based upon the sequence identifier of the data unit.

27. The apparatus of claim 26, wherein the receiver unit is further configured to determine the subband assigned to the pilot tone of the received unit by incrementing the subband assigned to a previously received data unit.

28. The apparatus of claim 27, wherein the subband assigned to the previously received data unit is incremented by an interval that is based upon the sequence identifier of the data unit.

29. An apparatus configured to select a subband to be assigned to a pilot tone comprising:
means for determining a channel parameter; and
means for selecting the subband to be assigned to a pilot tone based upon the channel parameter and a subband previously assigned to the pilot tone.

30. The apparatus of claim 29, further comprising:
means for determining whether the channel parameter satisfies a threshold condition; and
means for incrementing the subband previously assigned to the pilot tone by a predetermined interval, and selecting the incremented subband as the subband to be assigned to the pilot tone, if the channel parameter fails the threshold condition.

31. The apparatus of claim 29, wherein the channel parameter is a signal-to-noise ratio.

32. The apparatus of claim 31, wherein the channel parameter is a bit-error-rate.

33. A machine-readable medium carrying instructions for carrying out a method by one or more processors, the instructions comprising:
instructions for determining a channel parameter; and
instructions for selecting a subband to be assigned to a pilot tone based upon the channel parameter and a subband previously assigned to the pilot tone.

34. An apparatus configured to transmit multiple data units wherein each of the multiple data units includes a pilot tone comprising:
means for transmitting a first data unit, wherein the pilot tone of the first data unit is assigned to a first subband;
means for determining whether a pilot-hopping condition is met; and
means for transmitting a subsequent data unit, wherein
if the pilot-hopping condition is not met, the pilot tone of the subsequent data unit is associated with the first subband; and
if the pilot-hopping condition is met, the pilot tone of the subsequent unit is associated with an incremented subband.

35. The apparatus of claim 34, wherein the incremented subband is the subband of the previous data unit, incremented by a predetermined interval.

36. The apparatus of claim 34, wherein the means for determining whether a pilot-hopping condition is met further comprises means for determining a channel parameter.

37. The apparatus of claim 36, wherein the means for determining whether a pilot-hopping condition is met further comprises means for determining whether the channel parameter meets a threshold condition.

38. The apparatus of claim 36, wherein the means for determining whether a pilot-hopping condition is met further comprises means for receiving an indicator from a receiver.

39. A machine-readable medium carrying instructions for carrying out a method by one or more processors, the instructions comprising:
instructions for transmitting a first data unit including a pilot tone assigned to a first subband;
instructions for determining whether a pilot-hopping condition is met; and
instructions for transmitting a subsequent data unit including a second pilot tone, wherein
if the pilot-hopping condition is not met, the second pilot tone is associated with the first subband; and
if the pilot-hopping condition is met, the second pilot tone is associated with an incremented subband.

40. An apparatus configured to process a received data unit, the received data unit comprising a sequence identifier and a pilot tone associated with a subband, the apparatus comprising:
means for determining the sequence identifier of the received data unit; and
means for determining the subband associated with the pilot tone of the received data unit based upon the sequence identifier of the data unit.

41. The system of claim 40, wherein the means for determining the subband assigned to the pilot tone of the received data unit further comprises means for incrementing by an interval the subband associated with a previously received data unit, wherein the interval is based upon the sequence identifier of the received data unit.

42. A machine-readable medium carrying instructions for carrying out a method by one or more processors, the instructions comprising:
instructions for determining a sequence identifier of a data unit having a pilot tone; and
instructions for determining the subband associated with the pilot tone of the data unit based upon the sequence identifier of the data unit.
